(19) United States
(12) Patent Application Publication
(10) Pub. No.: US 2015/0077563 A1
(43) Pub. Date: Mar. 19, 2015

(54) Display system for a vehicle

(71) Applicant: Volker Niemz, Rutesheim (DE)

(72) Inventor: Volker Niemz, Rutesheim (DE)

(21) Appl. No.: 14/372,496

(22) PCT Filed: Dec. 5, 2012
(86) PCT No.: PCT/EP2012/074500

§ 371 Date: Oct. 20, 2014

(30) Foreign Application Priority Data
Jan. 17, 2012 (DE) 10 2012 200 636.2

(51) Int. Cl. B60R 1/00

(52) U.S. Cl. CPC B60R 1/00; B60R 2300/8066; B60R 2300/605
USPC 348/148

(57) ABSTRACT

The invention relates to a display system (10) for a vehicle (1), using which surroundings (30) of the vehicle (1) are able to be displayed, having at least one camera (11) for taking an image (20) of the surroundings (30), having a display unit (13), on which the image (20) is able to be shown, at least partially. According to the invention, it is provided that the display system (10) has a processing unit (12) which, if the image (20) includes at least one information area (21), recognizes the information area (21) automatically and processes the image (20) that is to be shown on the display unit (13), at least partially, in such a way that the information area (21) is able to be shown in a remaining image (22) on the display unit (13) in a view which is a mirror image with respect to the remaining image (22).

The present invention relates to a display system for a vehicle, which is able to display surroundings of the vehicle, having at least one camera for taking an image of the surroundings and having a display unit on which the image is able to be shown at least partially, according to the definition of the species in claim 1. The present invention also relates to a method for displaying the surroundings of a vehicle, a camera taking an image of the surroundings of the vehicle, a display unit showing the image at least partially, according to the definition of the species of independent claim 9.

### BACKGROUND INFORMATION

US 2002/0017985 A1 describes a display system for a vehicle, which displays on a display unit rear surroundings of the vehicle which were recorded by a plurality of recording devices. In this case, the display of the rear surroundings on the display unit simulates a display of the surroundings by a conventional mirror.

A disadvantage is that thereby characters which might include mirror-inverted information for the driver, such as letters, are displayed in a manner that is not legible to the driver.

### DISCLOSURE OF THE INVENTION

It is the object of the present invention to provide a display system and a method for displaying surroundings of a vehicle in which the safety in driving is increased. For this purpose, displaying the surroundings of the vehicle for the driver is supposed to be as simple and/or advantageous as possible, and in particular, the writing on signs, etc., is to be reproduced in an easily legible manner.

To achieve the object, a display system having the features of claim 1 is provided. Advantageous refinements of the display system are specified in the device claims. The object is further attained by a method having the features of independent claim 9. Advantageous refinements of the method are specified in the dependent method claims. Features and details that are described in connection with the display system according to the present invention also apply in connection with the method according to the present invention, and vice versa. In this context, the features mentioned in the claims and the description may be essential to the present invention either individually in isolation or in any combination.

According to the present invention, it is provided that the display system have a processing unit which, if the image includes at least one information area, recognizes the information area automatically and processes the image to be shown on the display unit at least partially in such a way that the information area is able to be shown in a remaining image on the display unit in a view which is a mirror image to the remaining image.

The display system provides a driver of the vehicle with information on surroundings of the vehicle in the form of at least one possibly processed image of the surroundings on the display unit. At least one camera of the display system, situated on the vehicle, records the surroundings for this purpose. A plurality of cameras may also be provided, in order to record the surroundings of the vehicle as thoroughly as possible. In this instance, the term surroundings may also include only a part of the surroundings, which surround the vehicle on all sides. For example, by the term surroundings one may understand only rearward surroundings. The image of the surroundings taken by the camera is shown by a display unit of the display system, which may be developed as a monitor, for example, in a manner advantageous for the driver. In this instance, the image taken by the camera may previously have been processed by the processing unit, at least partially. The recordings of a plurality of cameras may also be joined together to form a joint image.

It is therefore conceivable that the surroundings of the vehicle on the display unit, except for the information area, are displayed in a mirrored manner, that is, mirror-inverted. This means that “left” and “right” are exchanged, in contrast to “top” and “bottom”. This, above all, is the case when the rear surroundings of the vehicle are to be displayed on the display unit. For, the driver is used to observing the rearward surroundings of the vehicle as shown in conventional rearview mirrors. Consequently, the camera may be a rearview camera. In this instance, the camera records the rear surroundings of the vehicle.

However, representing the image on a display unit, which corresponds to a mirrored view, is not advantageous for all regions of the image of the surroundings shown on the display unit. For instance, characters and numbers shown mirror-inverted are poorly legible to the driver on the display unit, or not at all. One area for which the actually provided, particularly mirror-inverted representation of the image is disadvantageous for the driver will be designated in the following as the information area. If such an information area is present, the image taken by the camera is subdivided into at least one information area and into a remaining image, for which the actually provided, particularly mirror-inverted representation on the display unit is advantageous for the driver. In other words, the information area includes at least one symbol which, as a mirror image with respect to the remaining surroundings, includes information which the driver is able to apprehend more readily or apprehend in the first place. The remaining image corresponds to the image taken by the camera and/or to be represented on the display unit without the information area. The information area may include at least one character and/or one number and/or one special symbol as an element that is to be shown as a mirror image to the remaining surroundings. The information area may in addition or alternatively be a sign, particularly an unsymmetrical sign. In particular, the information area may include one or more words. For example, the information area may be a parking lot assignment sign, a caution sign, an inscription on the road pavement, a stop sign, an unsymmetrical sign such as a construction site sign or a rockfall warning sign. Arrows are preferably not detectable as information area. It is also possible that there are no or multiple information areas in an image.

According to the present invention, the information area is shown in the view which is a mirror image with respect to the remaining image, and is shown simultaneously with the remaining image. In particular, in a remaining image shown mirror-inverted on the display unit, the information area is shown simultaneously and not mirror-inverted. Therefore, information present in the information area is also easily accessible, especially legible to the driver, so that the driver is able to incorporate the information in his operating behavior and/or is not distracted from driving by information that is difficult to decipher. This increases safety in driving. The position of the information area on the image is not mirrored thereby, but only a mirror image of the information area is provided at an essentially unchanged position in the image. The position of the information area thus corresponds to the position of the information area in the remaining image if the information area were not being shown as a mirror image with respect to the remaining image. For the type of representation according to the present invention on the display unit, the processing unit, for instance, a processor, is provided in the display system, which recognizes an information area, if present, and processes the image obtained by the camera accordingly.

It may further be provided that the processing unit processes, in particular, mirrors, only the information area. Alternatively, the processing unit may also be used to process overall the image taken by the camera. For example, the processing unit may take only a relevant section out of the image passed on by the camera, and let it be shown on the display unit. The processing unit may, for instance, process the remaining image in such a way that the remaining image includes a mirror-inverted view of the surroundings if the camera does not pass on the image mirror-inverted to the processing unit. In order to obtain the not mirror-inverted information area within a mirror-inverted remaining image, the processing unit is able to process, particularly mirror, the information area and/or the remaining image. If the processing unit receives the image taken by the camera set on its head and mirror-inverted, the processing unit will process both the information area and the remaining image. If the image obtained from the camera is neither set on its head nor mirror-inverted, the processing unit will process only the remaining image. If the image obtained from the camera is only mirror-inverted, so that the image already corresponds to a view as mirrored, the processing unit will process only the information area.

The processing unit may undertake the processing of the information area and/or of the remaining image in a digital manner. In particular, the information area is integrated into the remaining image after the processing. In this instance, the edge of the information area may be adjusted to the remaining image, in order to avoid the formation of an edge. For example, the edge pixels of the information area may be interpolated or faded out with the remaining image. Alternatively, a specified edge around the information area remains intact, in order to point out to the driver the particularity of the information area. The processing unit may possibly process the information area in that the processing unit converts the information area, especially digitally, to the mirror image of the information area and passes it on to the display unit, the mirror image of the information area, in particular, being integrated into the remaining image.

In order to be able to recognize an information area, shapes may be stored in the processing unit with the aid of which the processing unit recognizes an information area. The processing unit is able to scan the image obtained from the camera for the stored shapes, and then recognize them as belonging in the information area. The shapes are particularly edge shapes, which reproduce an outer contour of an element that is to be mirrored. The shapes may, for instance, correspond to the contour of the individual letters. The processing unit is able to equate the recognized shapes themselves to the information area, or integrate the directly adjacent areas also jointly into the information area. A plurality of shapes may be connected to one information area. In that way, one word or text as a whole may be equated to an information area. An approximate position of the shapes, particularly of the text, may be sufficient to determine an information area. Optical character recognition (OCR) is thus not necessary. Alternatively, the recognition of an information area may take place via optical character recognition. It may also be provided that only a sign may be an information area. In this case, it is sufficient to recognize only the geometrical contour of the sign, and to equate this to the information area.

It may be provided that only shapes in a middle area are recognized as an information area. On the other hand, if an element, that is better recognizable to the driver as a mirror image with respect to the remaining image, is located in an outer area of the image taken by the camera, it is preferably assumed that this information is unimportant to the driver. This element is not recognized as belonging to an information area, and is represented as a mirror image with respect to the remaining image on the display unit. It may particularly be that only the middle area of the image is searched for an information area. It may be that the dimensions of the middle area are kept in a parameterized manner, and, in particular, are able to be set by the driver.

The display system is possibly able to have present at least one position information on a ground inclination in the surroundings of the vehicle and/or on a vehicle inclination. The display system is able to obtain the position information from an initial sensor system. The position information may include, for instance, a transverse acceleration of the vehicle, a state of at least one spring excursion and/or a state of a level regulation. The display system, especially the processing unit, is better able, while using the position information, to determine the information area with respect to its position, and situate the information area in the image that is to be passed on to the display unit more accurately. The display system may also pass on information recognized by the display system from the information area to other components of the vehicle, for instance, the speed limitation of a speed sign to a cruise control.

In order to pass on the image from the camera to the processing unit and/or from the processing unit to the display unit, the display system may have transmission elements, particularly cables. The wireless passing on of the images from the camera to the processing unit and/or from the processing unit to the display unit is alternatively also possible.

The display system according to the present invention provides the driver with views of surroundings of the vehicle, particularly of a motor vehicle. This may be about additional views to the views which the driver obtains by conventional rearview mirrors and/or the sight from the windows of the vehicle. For example, a blind spot may be reduced. Alternatively or in addition, the display system is able to replace at least partially the views which the driver obtains by conventional rearview mirrors and/or the sight from the windows of the vehicle.

The display system according to the present invention helps the driver while he is driving the vehicle, in that the display system represents surroundings, particularly close surroundings on the display unit. The display system according to the present invention may especially be used during a parking process and/or a process of leaving a parking space. The use of the display system may even be limited to a parking process and/or a process of leaving a parking space. Alternatively, the use of the display system is conceivable during the entire travel of the vehicle. The display system may include one or more cameras of the following cameras: one or more backing-up cameras, one or more front cameras, one or more side cameras. The display system may provide different views of the surroundings: one view in bird's-eye perspective onto the vehicle, one view directly onto a trailer coupling, one mirror-inverted view on the rear surroundings. In this instance, the display system will recognize an information area only, and process the image of the surroundings in such a way that the information area in one view, which is able to be shown in a mirror image situation with respect to the remaining image, if the information area in this view includes information that is better recognizable to the driver in this view, for instance, a no longer mirror-inverted writing. On the other hand, if no such information area is present, for instance, because in a view from the bird's-eye perspective the entire image is not shown mirror-inverted, the recognition drops out too, and the processing of the information area.

The present problem definition is also attained by a method in which a camera takes the surroundings of the vehicle. A processing unit recognizes whether the image taken by the camera includes an information area. When the processing unit has recognized an information area, before being shown on the display unit, the image is processed at least partially in such a way that the information area is shown in a remaining image on the display unit, in a view which is a mirror image with respect to the remaining image to be shown on the display unit.

Further measures improving the present invention result from the following description of exemplary embodiments of the present invention, which are illustrated schematically in the figures. All of the features and/or advantages yielded by the claims, the description or the drawings, including constructive details, spatial situations and method steps are able to be essential to the present invention both per se and in the most varied combinations. The figures show:

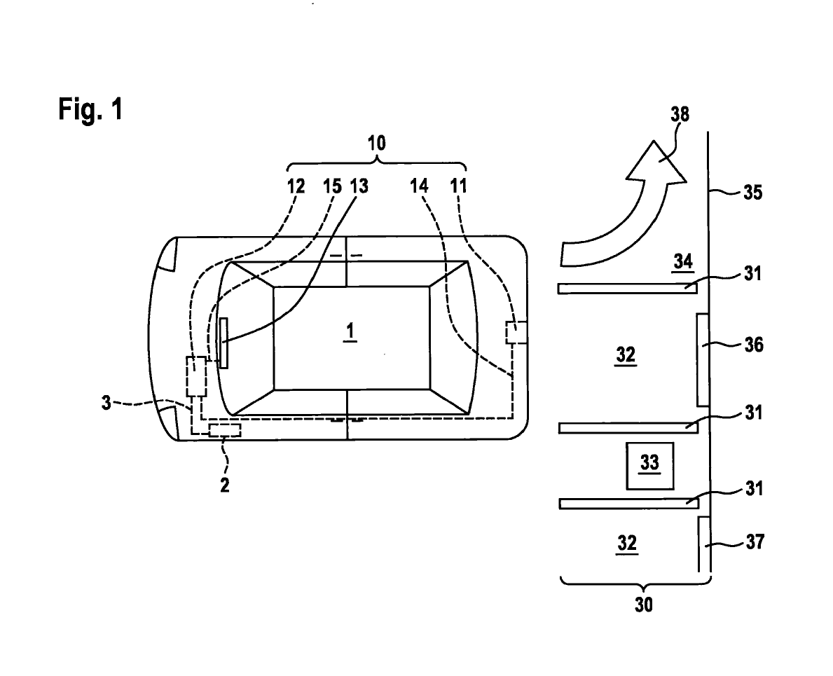

FIG. 1 a top view of a motor vehicle having a display system according to the present invention and rear surroundings of the motor vehicle,

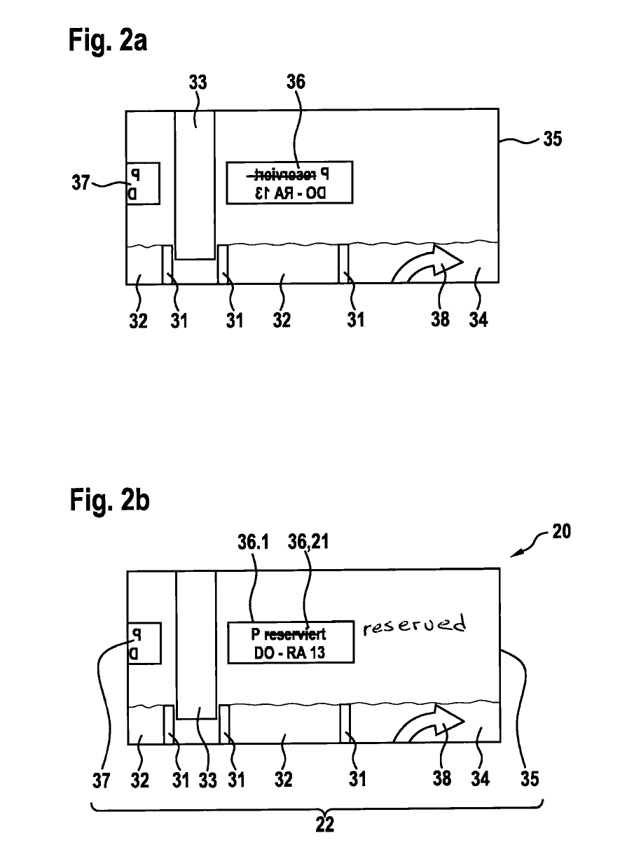

FIG. 2a an illustration of rear surroundings of the motor vehicle of FIG. 1 in a conventional inside rearview mirror,

FIG. 2b an illustration of the surroundings of FIG. 2a by a display system according to the present invention and according to a method of the present invention, and

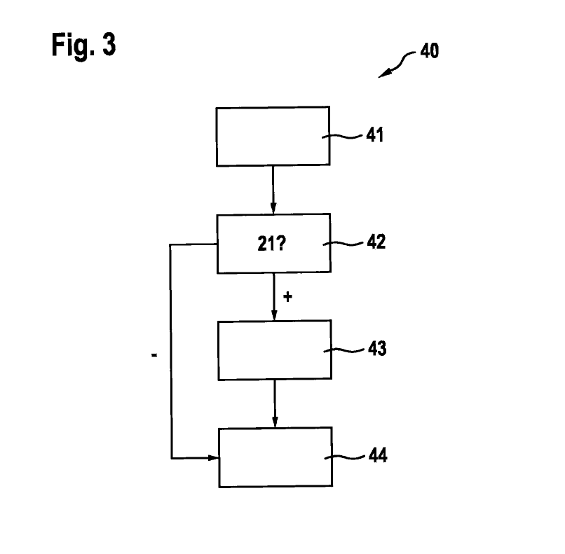

FIG. 3 a method according to the present invention.

Technical features having the same function or mode of operation are provided in FIGS. 1 to 3 with identical reference numerals.

FIG. 1 shows a motor vehicle 1, which is located in a parking garage, as well as rear surroundings 30 of motor vehicle 1, shown reduced in size in comparison to motor vehicle 1 in the parking garage. A display system 10 is situated in motor vehicle 1. Display system 10 has a rearview camera 11, which is situated in a rear region of motor vehicle 1 and which takes rear surroundings 30 digitally. Via a transmitting element 14, which is developed as a cable, rearview camera 11 transmits images 20 of rear surroundings 30, taken by rearview camera 11, to a processing unit 12 of display system 10. Processing unit 12 processes images 20 obtained from rearview camera 11 according to the present invention. Thereafter, processed images 20 are passed on to a display unit 13 of display system 10 via a transmitting element 15, which is developed as a cable. Display unit 13 may be developed as a monitor, and may be located on a dashboard or a middle console of motor vehicle 1. An initial sensor system 2 situated in motor vehicle 1 is able to pass on position information on the position of motor vehicle 1 via an additional transmitting element 3 to display system 10, particularly to processing unit 12.

Rear surroundings 30 has one and one-half parking space boxes 32, which are separated from one another by stripes 31 painted on parking garage floor 34. Furthermore, an arrow 38 is painted on parking garage floor 34. Between parking space boxes 32 there is a column 33. On a parking garage wall 35 there is a sign 36, 37 for each parking space box 32 which states that this parking space box 32 is reserved for a motor vehicle having a certain identification. If the driver of motor vehicle 1 looks into a conventional inside rearview mirror of motor vehicle 1, the driver will see the image shown in FIG. 2a in the inside rearview mirror. In this instance, signs 36, 37 are visible to the driver in a mirror-inverted manner, so that the writing is poorly legible to the driver, or not at all. The driver will be distracted from driving the vehicle by his attempt to read the mirror-inverted writing, so that the safety during driving is low.

By contrast, in FIG. 2b there is shown how rear surroundings 30, shown in FIG. 1, are represented by display system 10 according to the present invention. In this instance, a view onto display unit 13 is shown in FIG. 2b. Image 20, which is seen of the rear surroundings 30 on display unit 13, is subdivided: for one thing, into an information area 21, which corresponds to an image of sign 36, and for another, into a remaining image 22, which corresponds to image 20, without information area 21.

The remaining image 22 is shown mirror-inverted on display unit 13, and thus corresponds to the view from FIG. 2a. This means that the remaining surroundings, which include, among other things, column 33, arrow 38 and sign 37, are situated as in FIG. 2a. The position of information area 21 also corresponds to the position of sign 36 in FIG. 2a. However, according to the present invention, information area 21 itself is shown as a mirror image to remaining image 22 on display unit 13. The writing in information area 21 is thereby easily legible to the driver.

The driver is therefore able to read the writing easily and quickly, and is not distracted from driving by sign 36. Therefore, safety while driving is increased by display system 10 according to the present invention. Sign 37 is located on an outer area of image 20 shown on display unit 13, and is not recognized by display system 10 as an information area 21. Furthermore, a larger section of rear surroundings 30, in comparison to FIG. 2a, is shown on display unit 13.

FIG. 3 represents a method 40 according to the present invention, using which an illustration may be produced on display unit 13, as shown in FIG. 2b. First, rearview camera 11 takes rear surroundings 30 of motor vehicle 1 in a step 41, and passes images 20 thus taken to processing unit 12.

Processing unit 12 examines each of images 20 in a step 42 for whether an information area 21 is present. In this examination, it may be that processing unit 12 limits itself to a middle area of image 20 in which sign 36 is located, for example. Because of this, an outer area, in which sign 37 is located, for example, is not taken into account in this examination. Consequently, sign 37 is not recognized as information area 21. Image 20, or at least the middle area of image 20, are searched for shapes that are stored in processing unit 12. The shapes may correspond to the contour of letters and numbers. The contour of letters and numbers to be searched for is adjusted to the type in which image 20 is present in processing unit 12. If, for example, image 20 is mirror-inverted, the searching will be done for mirror-inverted shapes of letters and numbers. If processing unit 12 recognizes the stored shapes, processing unit 12 combines the shapes and their direct surroundings into one or more information areas 21. In the present example, the recognized shapes of the letters and numbers “P”, “r”, “e”, “s”, “e”, “r”, “v”, “i”, “e”, “r”, “t”, “D”, “O”, “R”, “A”, “1”, “3” are combined to an information area 21. In this connection, border 36.1 of sign 36 is helpful, which processing unit 12 is able to specify without difficulty as the border of information area 21.

If processing unit 12 determines that no information area 21 is present, which in FIG. 3 is symbolized by the mark “−”, then in a step 44, processing unit 12 passes on image 20 to display unit 13, on which image 20 is shown. In this case, it may optionally be provided, in a step that is not shown, that if image 20 is not passed on mirror-inverted by rearview camera 11, processing unit 12, before passing it on to display unit 13, converts the entire image 20 that is to be shown on display unit 13, to the desired, mirror-inverted view.

If, on the other hand, processing unit 12 determines that an information area 21 is present, which is symbolized in FIG. 3 by the “+” sign, processing unit 12 carries out step 43. In step 43, processing unit 12 first subdivides image 20 obtained from rearview camera 11 into information area 21 and into remaining image 22. Processing unit 12 processes image 20 to the extent that information area 21, after the processing of image 20, is able to be shown as a mirror image to remaining image 22, and at the same time, remaining image 22 is able to be shown, as in a conventional mirror of motor vehicle 1, on display unit 13. In this processing, processing unit 12 is able to process information area 21 and/or remaining image 22, particularly mirror it, depending on how processing unit 12 receives image 20 from rearview camera 11.

If processing unit 12, for instance, obtains an image 20 from rearview camera 11 which is set on its head and is mirror-inverted, and in which “top” and “bottom” as well as “left” and “right” are thus exchanged, processing unit 12 will mirror obtained image 20 for information area 21 both on a horizontal and on a vertical axis, while processing unit 12 will mirror remaining image 22 only on a horizontal axis. If, on the other hand, processing unit 12 obtains an image 20 from rearview camera 11, in which “top” and “bottom” as well as “left” and “right” are not exchanged, processing unit 12 will undertake no mirroring for information area 21, while processing unit 12 will mirror remaining image 22 only on a vertical axis. In all cases, the position of information area 21 will be maintained in remaining image 22.

After the processing, in the case of a present information area 21, step 44 also takes place, in which processing unit 12 passes on processed image 20 to display unit 13, on which image 20 is shown.

What is claimed is:

1. A display system (10) for a vehicle (1), using which surroundings (30) of the vehicle (1) are able to be displayed, having at least one camera (11) for taking an image (20) of surroundings (30), having a display unit (13), on which the image (20) is able to be shown at least partially, wherein the display system (10) has a processing unit (12) which, if the image (20) includes at least one information area (21), recognizes the information area (21) automatically and processes the image (20) that is to be shown on the display unit (13) at least partially in such a way that the information area (21) is able to be shown in a remaining image (22) on the display unit (13) in a view which is a mirror image with respect to the remaining image (22).

2. The display system (10) as recited in claim 1, wherein the camera (11) is a rearview camera (11) and is situated so that by the camera (11) an image (20) is able to be taken of the rear surroundings (30) of the vehicle (1).

3. The display system (10) as recited in claim 1 or 2, wherein the information area (21) includes at least one symbol which, in the view which is a mirror image to the remaining image (22) that is to be shown on display unit (13), includes information for the driver.

4. The display system (10) as recited in one of the preceding claims, wherein the information area (21) includes at least one character and/or one number and/or one special character and/or is a sign, in particular, the information area (21) being at least partially surrounded by a border (36.1).

5. The display system (10) as recited in one of the preceding claims, wherein the information area (21) is located only in a middle area of the image (20).

6. The display system (10) as recited in one of the preceding claims, wherein shapes are stored in the processing unit (12) with the aid of which the processing unit (12) recognizes the information area (21).

7. The display system (10) as recited in one of the preceding claims, wherein the processing unit (12) undertakes the processing digitally, particularly the information area (21) being integrated into the remaining image (22) after the processing.

8. The display system (10) as recited in one of the preceding claims, wherein the processing unit (12) determines the position of the information area (21) by at least one position information on a ground inclination and/or a vehicle inclination which the processing unit (12) receives.

9. A method (40) for displaying surroundings (30) of a vehicle (1), a camera (11) taking an image (20) of the surroundings (30) of the vehicle (1); a display unit (13) showing the image (20) at least partially, wherein a processing unit (12) recognizes whether the image (20) includes an information area (21), and, when the processing unit (12) has recognized an information area (21), it processes the image (20) that is to be shown on the display unit (13) at least partially in such a way that the information area (21) is shown in a remaining image (22) on the display unit (13) in a view which is a mirror image with respect to the remaining image (22).

10. The method (40) as recited in claim 9, wherein it is operated using a display system (10) as recited in one of claims 1 through 8.
